(19) United States
(12) Patent Application Publication
(10) Pub. No.: US 2004/0143368 A1
(43) Pub. Date: Jul. 22, 2004

(54) Operating utility devices in a master-agent network environment

(76) Inventors: Robert E. May, Lakeville, MN (US); Stephen X. Skaff, Owatonna, MN (US)

Correspondence Address: MERCHANT & GOULD PC, P.O. BOX 2903, MINNEAPOLIS, MN, 55402-0903, US

(21) Appl. No.: 10/348,512

(22) Filed: Jan. 21, 2003

(51) Int. Cl. G06F 17/00

(52) U.S. Cl. 700/241

(57) ABSTRACT

A system and method is disclosed for managing, i.e., control and monitoring, processes associated with a group of utility devices. The utility devices in the group may be of the same or different types of devices. For example, one or all of the utility devices in the group may be a warewashing machine. Regardless of type, each utility device in the group is provided an agent control unit, which is a controller responsible for locally overseeing operation of the various processes performed by each utility device. A master control unit provides a field person with control over and the ability to monitor processes performed by all utility devices in the group by providing a single device operable to communicate with the agent control units associated with the utility devices. In response to receiving an instruction from a field person, the master control unit places the instruction in a format recognizable to all of the agent control units associated with a utility device in the group and transmits same to the appropriate agent control unit. In response to receiving an instruction issued by the master control unit, the associated agent control unit administers the task specified therein.

### TECHNICAL FIELD

The invention relates generally to a network environment of utility devices, and more particularly, to monitoring and controlling processes of the utility devices using a master computing device.

### BACKGROUND OF THE INVENTION

Devices such as warewashing machines, laundry machines, chemical dispense systems/devices and the like may generally be referred to as “utility devices” because these devices are used to perform some kind of utility. For instance, a warewashing machine is used to wash cooking utensils, dishes and various other kitchen-related objects provided to a washing chamber of the machine. Various types of utility devices are frequently used by large hotels, restaurants, casinos and campuses to perform various utilities associated with service operations performed at these facilities. As an example of such diversity, hotels typically contain one or more restaurants, and therefore require laundry machines and warewashing machines to clean and sanitize the linens and kitchen wares, respectively, used by patrons of the hotel-restaurant. The number of laundry and warewashing machines that the hotel-restaurant uses may depend on many factors, but most certainly is affected by the number of patrons that visit the hotel-restaurant on a daily basis.

Processes of a utility device are often monitored and controlled by a field person responsible for maintaining operation of the utility device. Monitoring such processes may include, for instance, determining the number of times that the utility device has been used to perform a particular process or determining an average or instantaneous operating parameter associated with a particular process. Controlling processes of the utility device may include, for example, setting an operating parameter associated with a particular process or activating/de-activating the utility device. A more specific example of controlling a utility device would be defining a temperature for the rinse agent used to rinse detergent from articles washed by a warewashing machine.

A controller is typically coupled to a utility device to enable a field person to locally control processes of the utility device. The controller receives input from the field person and thereafter oversees operation of the utility device based on the received input. The controller also receives sensed information associated with various processes performed by the utility device and locally controls operation of the utility device based on this sensed information. In order to enable a field person to monitor this sensed information and to provide facilitated control over the utility device, the controller typically includes a human-machine interface (HMI). The HMI presents various types of information associated with the utility device to the field person. The presented information includes operating parameters associated with one or more processes performed by the utility device as well as selection elements for modifying or setting these operating parameters.

The addition of HMI 's to improve a field person's ability to locally control and monitor operations of a utility device has resulted in significant advancements in the field of service maintenance for utility devices. However, different models and types of utility devices use different models and types of controllers, and therefore different HMI's. Thus, a field person responsible for servicing multiple utility devices must be familiar with, or at least personally carry reference manuals for, each of the different controllers and associated HMI's associated with these multiple utility devices. Having to reference multiple reference manuals is not only burdensome for the field person, but also adversely affects the sheer number of utility devices that the field person may maintain on a daily basis. As such, current systems do not provide a means for optimizing resources with respect to controlling and monitoring a large number of utility devices by a field person.

### SUMMARY OF THE INVENTION

In accordance with the present invention, the above and other problems are solved by a system and method for managing processes associated with a group of utility devices. In a specific embodiment, the utility devices are chemical dispense devices, wherein each chemical dispense device is operable to dispense at least one chemical product to a utility device for applying the at least one chemical product to one or more objects. Each chemical dispense device in the group is provided an agent control unit, which is a controller responsible for locally overseeing operation of the various processes associated with a chemical dispense device. A master control unit provides a field person with control over and the ability to monitor processes associated with all chemical dispense devices in the group. As such, the master control unit is a single device operable to communicate with all agent control units associated with the group of chemical dispense devices.

In accordance with one embodiment of the present invention, each of the utility devices in the group perform substantially similar functions and operate in a substantially similar manner with respect to one another, and therefore are considered the same “type” of utility device. For example, each utility device in the group may be a warewashing machine. In accordance with another embodiment of the present invention, at least one utility device in the group performs a substantially different function and operates in a substantially different manner than at least one other utility device in the group. As such, these two utility devices are considered different “types” of utility device. Illustrating this embodiment, a first utility device in the group may be a warewashing machine, whereas a second utility device in the group may be a laundry machine.

To request control over or monitor processes performed by a utility device, a field person first inputs an instruction into the master control unit. The instruction specifies a task that is to be performed by the agent control unit associated with the utility device to be controlled and/or monitored by the field person. Once received by the master control unit, the instruction is formatted into a packet-based structure having pre-defined fields and data recognizable to all agent control units associated with the utility devices in the group. Such a common protocol enables a field person to utilize a single master control unit to manage the various processes associated with each of the utility devices in the group. Once formatted into the packet-based structure, the master control unit transmits the instruction to the agent control unit associated with the utility device that is to be controlled and/or monitored by the field person. In response to receiving an instruction issued by the master control unit, the associated agent control unit administers the task specified therein.

In an embodiment, the task specified in an instruction issued to an agent control unit by the master control unit may be a request for the agent control unit to reply with certain information related to operation of the utility device associated with the agent control unit. For example, the task may request the agent control unit to determine and return to the master control unit an operating parameter associated with a particular process of the utility device. In a further embodiment, the task specified in an instruction issued to an agent control unit by the master control unit may request that the agent control unit perform an operation associated with a particular process of the utility device. Illustrating such, the task may request that the agent control unit set an operating parameter associated with the particular process to a specified value.

The master control unit may be any type of computing device operable to communicate with the agent control units over either a wire-based or wireless interface. In a first embodiment, the master control unit is a mobile computing device, e.g., a handheld personal digital assistant, a cellular phone or a laptop computer, that the field person may carry from agent control unit to agent control unit. In a second embodiment, the master control unit may be a desktop computer located at a facility and communicatively connected to each of the agent control units. In either embodiment, the master control unit may be a client computer that downloads instructions issued by a field person using a network connection, e.g., the Internet, an intranet, etc., to a server computer. The field person inputs the instructions using a workstation connected to the server computer by a direct communication link or a remote computer that accesses the server computer using a network connection.

The present invention may be implemented as a computer process, a computing system or as an article of manufacture, such as, a computer program product. The computer program product may be a solid state, non-volatile memory device or a computer storage media readable by a computer system and encoding a computer program of instructions for executing a computer process. The computer program product may also be a propagated signal on a carrier readable by a computing system and encoding a computer program of instructions for executing a computer process.

These and various other features as well as advantages, which characterize the present invention, will be apparent from a reading of the following detailed description and a review of the associated drawings.

### BRIEF DESCRIPTION OF THE DRAWINGS

FIG. 1 illustrates components of a utility device in accordance with an embodiment of the present invention.

FIG. 2 illustrates a schematic representation of a system for managing a group of utility devices using a single master control unit in accordance with an embodiment of the present invention.

FIG. 3 illustrates the system of FIG. 2 in more detail in accordance with an embodiment of the present invention.

FIG. 4 depicts a block diagram of a suitable computing environment in which an embodiment of the present invention may be implemented.

FIG. 5 is a flow diagram that illustrates operational characteristics for managing processes of a group of utility devices using a single master control unit in accordance with an embodiment of the present invention.

FIG. 6 depicts a command packet for specifying a task relating to a process associated with a utility device in accordance with an embodiment of the present invention.

FIG. 7 depicts a reply packet transmitted by an agent control unit in responding to a request for information contained in a command packet in accordance with an embodiment of the present invention.

FIG. 8 is a flow diagram that illustrates operational characteristics performed by an agent control unit in response to reception of a command packet issued by a master control unit in accordance with an embodiment of the present invention.

### DETAILED DESCRIPTION

The present invention and its various embodiments are described in detail below with reference to the figures. When referring to the figures, like structures and elements shown throughout are indicated with like reference numerals. Objects depicted in the figures that are covered by another object, as well as the reference annotations thereto, are shown using dashed lines.

The present invention relates to managing processes of a group of utility devices using a common master control unit. The term “managing” is broadly used herein to refer to controlling and/or monitoring processes of each utility device in the group. The term “process” is used herein to broadly refer to any operation performed by a utility device, or component thereof. In accordance with an embodiment of the present invention, each of the utility devices in the group of utility devices is provided with a local processor, referred to herein as an “agent control unit,” responsible for administering commands issued by the common master control unit. The group of utility devices may include devices of different types. For example, without limitation, one utility device may be a warewashing machine, a second utility device may be a laundry machine and a third utility device may be a vending machine. Alternatively, the group of utility devices may include only devices of the same type. For example, without limitation, each of the utility devices may be a warewashing machine.

The present invention is described herein using a warewashing machine to illustrate interaction between the master control unit and an agent control unit associated with the warewashing machine. It should be appreciated, however, that the present invention encompasses any type of utility device that performs operations under direction of a local processor, such as the agent control unit described in accordance with an embodiment of the invention. Exemplary utility devices for use with the present invention include, but are not limited to, vending machines, chemical dispense systems or devices, clean-in-place (CIP) systems, car wash systems and laundry systems. Furthermore, utility devices for use with the present invention may be used in any type of setting, such as, for example, a cafeteria, a bakery, a dairy plant, a chemical plant, a manufacturing plant, a hotel, a business or college campus, a building and a military base.

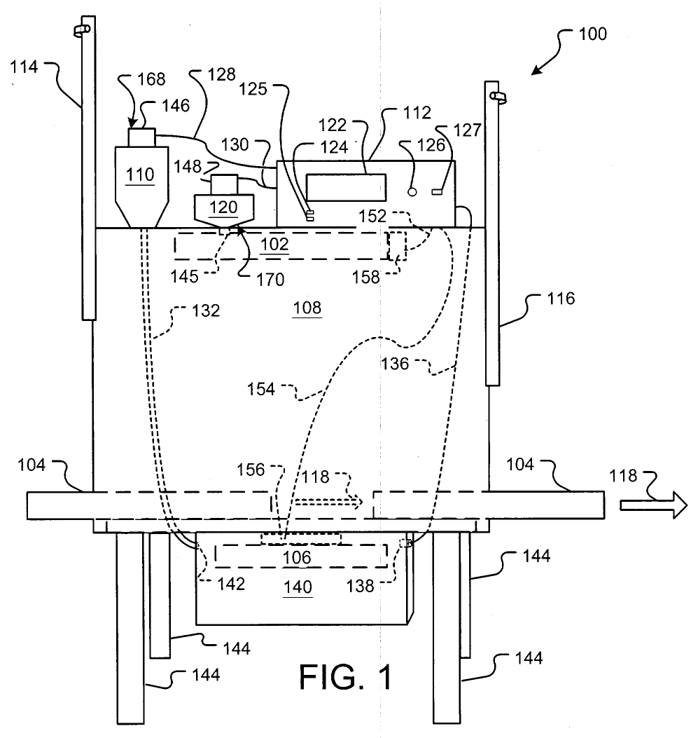

Referring now to FIG. 1, a warewashing machine 100 for use with the present invention is shown in accordance with an exemplary embodiment for a utility device. The warewashing machine 1100 is used to clean all types of dishware and kitchen objects, such as, without limitation, pots and pans used in restaurants, cafeterias and bakeries. Objects washed by the warewashing machine 100 are hereinafter referred to as “articles.” The articles are provided to the warewashing machine 100 on article racks 104. The warewashing machine 100 may be a commercial dump or fill-type dish machine with standard article racks 104, although other cleaning apparatuses may be employed, including, without limitation, animal cage washers used in animal research areas.

The warewashing machine 100 includes a washing chamber 108, which, in the embodiment shown is enclosed by an entry sliding door 114 and an exit sliding door 116. The washing chamber 108 is supported above ground level by a plurality of legs 144. In operation, each article rack 104 carries one or more articles to be cleaned and/or sanitized by the warewashing machine 100 into the washing chamber 108 through an opened entry sliding door 114. Arrows 118, which are provided in FIG. 1 for illustration purposes only, show the direction of article racks 104 through the washing chamber 108 in accordance with an embodiment of the present invention. Once an article rack 104 is located inside the washing chamber 108, the entry sliding door 114 and the exit sliding door 116 are both closed to fully contain the washing chamber 108 on all sides.

A rinse module 102 is provided within or directly above the washing chamber 108 for applying a rinse agent to articles contained in the article racks 104. Although water is hereinafter described as the exemplary rinse agent, it should be appreciated that other rinse agents may be applied to the articles by the rinse module 102. In an embodiment, the rinse module 102 includes arms (not shown) operably mounted to a spindle (not shown) for rotation about the spindle axis. The arms of the rinse module 102 include a plurality of openings (not shown) through which water is passed to articles placed in the washing chamber 108. The rinse module 102 includes a processing module 158 responsible for operation of the rinse module 102, such as, without limitation, spinning the rinse module arms at a certain velocity and allowing the dispensing of water through the holes in the rinse module arms.

A wash module 106 is provided within or directly below the washing chamber 108 for applying a chemical solution to articles placed in the racks 104. The chemical solution cleans and sanitizes the articles for subsequent use in eating, cooking or otherwise utilizing. Like the rinse module 102, the wash module 106 includes arms (not shown) operably mounted to a spindle (not shown) for rotation about the spindle axis. The arms of the wash module 106 include a plurality of openings (not shown) through which the chemical solution is passed to articles placed in the washing chamber 108. The wash module 106 includes a processing module 156 responsible for operation of the wash module 106, such as, without limitation, spinning the wash module arms at a certain velocity and allowing the dispensing of chemical product through the holes in the wash module arms.

The chemical solution is formed and stored in a solution tank 140 positioned underneath the washing chamber 108. The chemical solution is formed as a combination of water provided by the rinse module 102 and one or more chemical products. For illustration purposes, and not by means of limitation, the chemical solution formed in the solution tank 140 is a combination of a single chemical product and water. In an embodiment, the chemical product is a cleaning product, such as, without limitation, detergent, soap or other cleaning chemical. Prior to being provided to the solution tank 140, the chemical product used to form the chemical solution is stored in a product reservoir 110 in either a solid or liquid form. If the chemical product is stored as a solid, water is applied to the product to liquefy the chemical product such that the product may be provided to the solution tank 140 by way of a supply hose 132.

The chemical product is stored in a product reservoir 110 and dispensed to the solution tank 140 under the direction of a chemical product dispense processor 146. Collectively, the product dispense processor 146 and the product reservoir 110 constitute a “chemical dispense device” 168, and therefore can be considered a utility device separate from the warewashing machine 100 in accordance with the present invention. Indeed, processes of this chemical dispense system 168 are administered by the agent control unit 112.

Water is stored in a water reservoir 120 and dispensed into the washing chamber 108 by the rinse module 102. Water passes from the water reservoir 120 to the rinse module 102 by way of a coupling 145 therebetween. The rinse module 102 then applies the water to articles contained in a rack 104 situated in the washing chamber 108. An opening (not shown) is provided between the solution tank 140 and the washing chamber 108 to allow water provided to the washing chamber 108 to enter the solution tank 140. Water provided to the washing chamber 108 by the rinse module 102 passes through the opening into the solution tank 140, therein combining with pre-existing chemical solution to further dilute the chemical solution and therefore lower the concentration of chemical product in the solution.

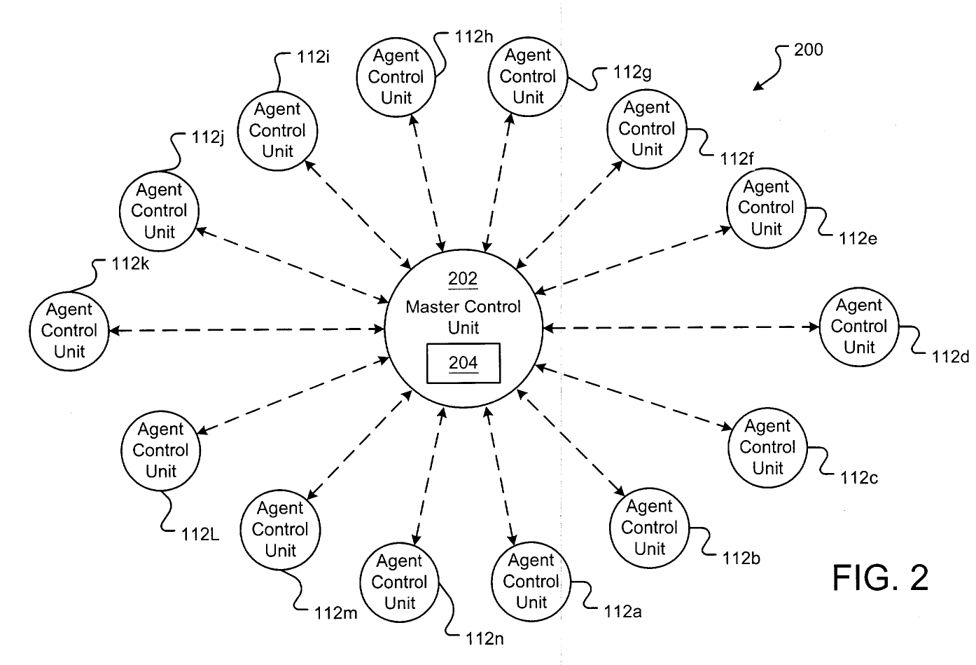

In an embodiment of the present invention, a field person manages, i.e., controls and monitors, processes associated with the warewashing machine 100 using a master-agent system (200 in FIG. 2). Although referred to as being associated with the warewashing machine 100, it should be appreciated that the processes being controlled and monitored by the master-agent system 200 are not only associated with the actual warewashing machine 100, but also various utility devices serving as components to the warewashing machine 100. For example, many of the processes associated with the warewashing machine 100 are actually associated with, and even performed by, the chemical dispense device 168, which is responsible for dispensing a chemical product to the solution tank 140 for application to articles contained in racks 104, as discussed in further detail below.

In an embodiment, the master-agent system 200 includes a master control unit (202 in FIG. 2), which may any type of computing device capable of sending commands and receiving information over a wired or wireless interface. Some exemplary master control units 202 include, without limitation, a personal digital assistant (PDA), a workstation, a personal computer, a laptop computer, a cellular or land-based telephone, etc. Regardless of the type of computing device used, the master control unit 202 communicates commands entered by the field person to a processing module 112 local to the warewashing machine 100. In response to receiving a command issued by the master control unit 202, the local processing module 112 controls processes of the warewashing machine 100 based on instructions specified in the command. Due to the master-agent, or “masterslave,” relationship between the master control unit 202 and the local processing module 112, the local processing module 112 is referred to herein as an “agent control unit.”

The agent control unit 112 includes a control module (internal to the agent control unit 112), a wireless control port 126, a wired control port 127, and one or more display devices or modules, such as, without limitation, first and second status indicators, e.g., light emitting diodes (LED's), 124 and 125 and a graphical user interface 126. The wireless control port 126 and the wired control port 127 enable the agent control unit 112 to receive commands and transmit information to the master control unit 220.

In response to commands received from the master control unit 202 through either the wireless control port 126 or the wired control port 127, the control module performs operations stored as firmware or software to locally control and monitor various tasks associated the warewashing machine 100. These operations direct various components associated with the warewashing machine 100 to perform various tasks administered during a given wash cycle. These components include, without limitation, the rinse module 102, the wash module 106, the chemical dispense device 168 and a chemical dispense device 170. For example, the control module controls initiation of a wash cycle for each rack 104, provided to the warewashing machine 100, dispensing of the chemical product to the solution tank 140, application of the chemical solution to the articles contained in the rack 104, and application of water to the articles contained in the rack 104.

The control module also measures conductivity of the chemical solution resident in the solution tank 140, and based on this measurement, controls the amount of chemical product that the product reservoir 110 dispenses to the solution tank 140. Furthermore, the control module generates information for display on the graphical user interface 122 as well as first and second status indicators 124 and 125 based on the various tasks performed and monitored by the control module. In a preferred embodiment, the control module is a special-purpose controller manufactured by NOVA Controls. However, it should be appreciated that the control module may be any type or make of controller known to those skilled in the art.

Instructions by the control module to perform various tasks are transmitted to the appropriate components using a chemical product output control line 128, a water output control line 130, a rinse module control line 152 and a wash module control line 154, each of which are input to the agent control unit 112. Further, the control module monitors conductivity of the chemical solution resident in the solution tank 140 using a conductivity input control line 136, which is also input to the agent control unit 112.

The chemical product output control line 128 couples the agent control unit 112 to the product dispense processor 146 thereby enabling the agent control unit 112 to locally control and monitor processes associated with the chemical dispense device 168. Under direction of the control module, the agent control unit 112 transmits signals to the product dispense processor 146 over the chemical product output control line 128. These signals direct the product dispense processor 146 to dispense a particular volume of chemical product to the solution tank 140. If the chemical product is stored in the product reservoir 110 in a solid form, the product dispense processor 146 activates a water pump that applies a predetermined volume or water to the solidified chemical product. Upon the application of this predetermined volume of water, a predetermined volume of the chemical product in a liquid form is created and dispensed out of the product reservoir 110.

The wash module control line 154 couples the agent control unit 112 to the processor 156, which as noted above, is responsible for operation of the wash module 106, i.e., dispensing of chemical solution, velocity of the spray arms of the wash module 106, etc. Under direction of the control module, the agent control unit 112 controls operation of the wash module 106 by issuing command signals to the wash module processor 156. Based on such control, the control module can determine whether the wash module 106 is currently operating.

The water output control line 130 couples the agent control unit 112 to a processor 148 responsible for dispensing water from the water reservoir 120. In an embodiment, the water reservoir processor 148 controls operation of a water pump (not shown) that pushes water through an output of the water reservoir 120 and into the rinse module 102. Under direction of the control module, the agent control unit 112 transmits signals to the water reservoir processor 148 over the water output control line 130. These signals direct the water reservoir processor 148 to activate the water pump to dispense a predetermined volume of water contained in the water reservoir 120 to the rinse module 102. Collectively, the water reservoir processor 148 and the water reservoir 120 constitute a “chemical dispense device” 170, and therefore can be considered a utility device separate from the warewashing machine 100 in accordance with the present invention. Indeed, processes of this chemical dispense system 170 are administered by the agent control unit 112.

Almost simultaneously to activation of the water pump and under the direction of the control module, the agent control unit 112 also directs the rinse module 102 to provide the water to the washing chamber 108 for application to articles contained in an article rack 104 currently situated therein. To accomplish this, the agent control unit 112 transmits signals to the rinse module processor 158, which as noted above, is responsible for dispensing water from the rinse module 102. These signals are communicated to the rinse module processor 158 by way of the rinse module control line 152. The rinse module processor 158 dispenses water from the rinse module 102 and to the articles in the washing chamber 108. From the washing chamber 108, the water passes to the solution tank 140, where the water combines with chemical solution already contained in the tank 140, thereby diluting the solution.

As the chemical solution resides in the solution tank 140, the control module monitors conductivity of the chemical solution. To accomplish this, the conductivity input control line 136 couples the agent control unit 112 to one or more conductivity cells 138 that sense information related to concentration of the chemical product relative to the chemical solution. This sensed information, which is provided to the agent control unit 112 over the conductivity input control line 136, is used by the control module to calculate percent (%) concentration of the chemical product relative to the chemical solution. Such conductivity cells and the method for determining % concentration are well known in the art and not described in further detail herein. For example, U.S. Pat. No. 4,733,798, which is incorporated by reference into this application, teaches both conventional electrode-bearing conductivity cells and electrode-less conductivity cells as well as measuring and controlling concentration of a chemical solution.

In an embodiment, the first and second status indicators 124 and 125 indicate the current operation of the warewashing machine 100. For example, the first status indicator 124 may indicate to users that the warewashing machine 100 is currently activated and in the middle of a wash cycle. The second status indicator 125 may indicate to users that the warewashing machine 100 is not only activated, but that the chemical product is currently being dispensed to the solution tank 140. It should be appreciated that the status indicators 124 and 125 may be used for any other purpose related to operating characteristics of the warewashing machine 100.

The graphical user interface 122 provides a presentation and control interface that enables a field person to locally monitor and control processes of the warewashing machine 100. As such, control and monitoring of the warewashing machine 100 using the graphical user interface 122 is an alternative approach to using the master control unit 202 described above.

Operation of the warewashing machine 100 commences after both the entry sliding door 114 and the exit sliding door 116 are closed with a rack 104 being located substantially underneath the rinse module 102 and substantially above the wash module 106. Initially, the chemical solution is applied to the articles by the wash module 106 under direction of the control module. Application of the chemical solution to the articles is maintained for a predetermined period in time, as determined by the control module. After the chemical solution 106 is applied to the articles, the control module controls the rinse module 102 to apply water to the articles for rinsing the chemical solution away from the articles. Like the wash module 106, the rinse module 102 is operated for a predetermined period in time, as determined by the control module. After rinsing, the wash cycle is complete and the exit sliding door 116 is opened such that the rack 104 may be removed from the washing chamber 108 to make the warewashing machine 100 available for use by subsequent article racks 104.

FIG. 2 illustrates a master-agent system 200 wherein a master control unit 202 is used by a field person to control and monitor processes associated with a group of utility devices (not shown) in accordance with an embodiment of the present invention. The utility devices may be located either at a single facility or at different facilities. Each utility device is associated with an agent control unit 112, which are shown in FIG. 2 as agent control units 112a through 112n. Agent control units 112a through 112n are shown to illustrate the master-agent system 200, and are not intended to limit the master control unit 202 to control over the number (14) of utility devices shown. Indeed, the master control unit 202 may interact with any number of agent control units 112 to control and monitor any number of utility devices.

In accordance with a first embodiment, at least one utility device in the group is a different type of utility device than each of the other utility devices in the group. As such, this at least one utility device performs a substantially different function and operates in a substantially different manner than each of the other utility devices in the group. For instance, a utility device in the group may be a laundry machine whereas each other utility device in the group may be a warewashing machine 100. In accordance with a second embodiment, each utility device in the group is substantially the same type of utility device. As such, each utility device in the group performs substantially the same function and operates in substantially the same manner. For instance, each utility device in the group may be a warewashing device 100. Additionally, regardless of whether the utility devices in the group are of the same “type,” each utility device included within the group may each be dependent upon processes associated with other utility devices, such as the case with the dependency between the chemical dispense device 168 and the warewashing machine 100 shown in FIG. 1.

It should be appreciated that the master control unit 202 may any type of computing device capable of sending commands to and receiving information from an agent control unit 112. Some exemplary master control units 202 include, without limitation, a personal digital assistant (PDA), a workstation, a personal computer, a laptop computer, a cellular or land-based telephone, etc. Furthermore, in an embodiment, the master control unit 202 may be a client computer, e.g., PDA, desktop, laptop or workstation, connecting to a server computer over a network connection, such as the Internet. In this embodiment, a field person may control and monitor processes of a utility device as the field person communicates with the agent control unit 112 associated with the utility device from a remote location. Alternatively, the field person may utilize the master control unit 112 to control and monitor processes of a utility device while present at substantially the same physical location, i.e., facility, as the utility device. Regardless of the type of computing device used, the master control unit 202 communicates commands entered by the field person to an agent control unit 112 local to the utility device.

Field persons interact with the master control unit 202 using a display device 204. In an embodiment wherein a field person accesses the master control unit 202 from a remote location, the display device 204 is part of the client computer used by the field person to access the master control unit 202. In an embodiment wherein the field person accesses the master control unit 202 locally, the display device 204 is part of the master control unit 202. A graphical user interface displayed on the display device 204 provides the capability for the field person to monitor and control processes of the utility device.

With respect to monitoring warewashing operations, the graphical user interface presented on the display device 204 displays information related to current operating conditions and parameters of the wash cycle. For example, the graphical user interface may display, without limitation, whether articles are being rinsed or cleaned, the amount of time left in a current wash cycle, the temperature of the chemical solution, the pressure of the rinse or chemical solution being applied to the articles, the temperature of the rinse water, etc.

With respect to controlling warewashing operations, the graphical user interface displayed on the display device presents information in the form selection objects that enable the field person to define or modify operating parameters for the warewashing machine 100. These operating parameters include, without limitation, a setpoint value for conductivity of the chemical solution formed and stored in the solution tank 140, the length in time of a wash cycle, the length in time of a rinse cycle and the length in time that the chemical solution is applied to articles contained in the washing chamber 108. The setpoint value for conductivity is defined herein as a user-defined % concentration for a chemical product relative to the chemical solution formed in the solution tank 140. Such functionality may be desired because different chemical products are typically associated with different set point values for solutions formed in the solution tank 140.

Various other parameters and operating conditions may be defined or selected by a field person through the graphical user interface displayed on the display device 204 including, without limitation, a temperature for the rinse water, a rate in which conductivity is sensed, or monitored, by the one or more conductivity cells 138, a rate in which a chemical product is dispensed if the warewashing operations are time-based, e.g., in implementations where the agent control unit 112 does not control dispensing based on information sensed by the one or more conductivity cells 138, a rate in which water is dispensed and velocity of the revolution of wash and rinse arms about a spindle axis.

Communications passed between the master control unit 202 and each of the agent control units 112 are formatted based on a single command protocol in accordance with an embodiment of the present invention. The single command, which is issued by the master control unit 202 for a particular agent control unit 112, is transmitted to the agent control unit 112 over either a wireless communication link, such as, without limitation, infrared, sonic or radio communication, or a wired communication link, such as, without limitation, copper-based or fiber optic communication media. The communications paths between the master control unit 202 and each of the agent control units 112a-112n are shown in dashed lines to illustrate the alternative embodiments of wired and wireless interfaces between the master control unit 202 and the agent control units 112a-1112n.

In accordance with the single command protocol, commands that may be issued by the master control unit 202 to each of the agent control units 112a-112n belong in one of the following categories: Reset commands, Clear commands, Dump commands and Set commands. The Reset, Set and Clear commands enable a field person to control processes of a utility device using the master control unit 202. The Reset command directs the agent control unit 112 to reboot. The Clear command directs the agent control unit 112 to clear specified information stored on the agent control unit 112. The Set command directs the agent control unit 112 to administer a specified operation associated with a process of the utility device. These operations may include, without limitation, modifying a defined value or operating parameter associated with the process, activating a particular component and performing a particular operation. An example of an operating parameter is the conductivity setpoint for a chemical product or temperature of a rinse agent. The Dump command enables a field person to monitor processes of a utility device using the master control unit 202. In doing this, the Dump command directs the agent control unit 112 to reply with specified information, such as, without limitation, the defined setpoint value of a chemical product relative to a chemical solution associated with the utility device, the current conductivity of the chemical solution, the temperature of the chemical solution and the length in time that the rinse module 106 and the wash module 104 have been operating for each wash cycle.

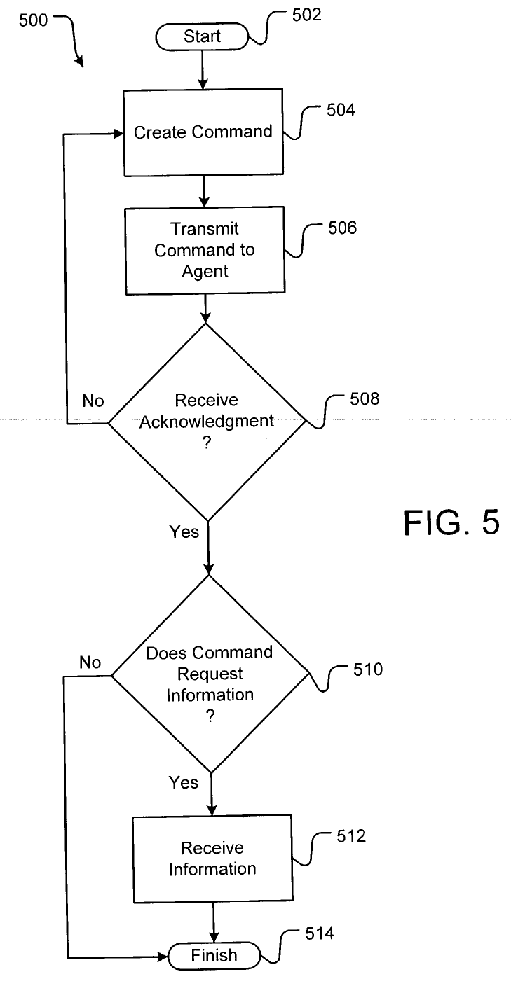

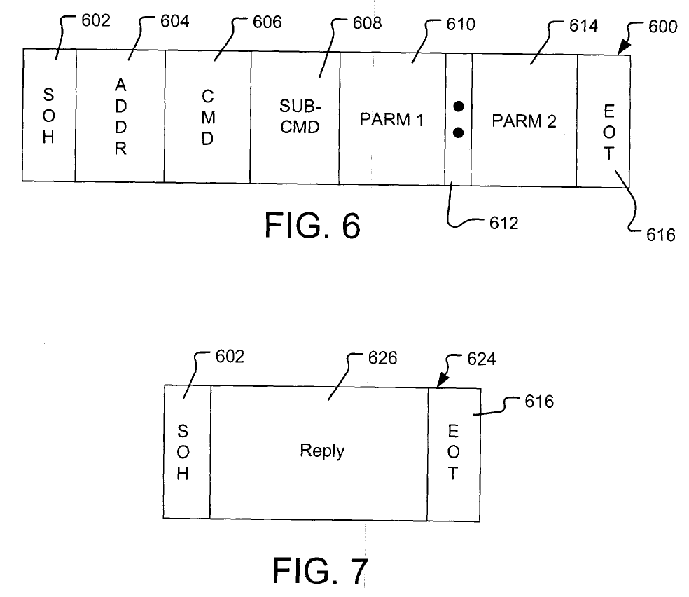

In order for the master control unit 202 to effectively enable a field person to control and monitor processes of each device in the group of utility devices of the master-agent system 200, the control module for each agent control unit 112a-112n is programmed to recognize the aforementioned commands, and in response, administer the task specified in the request. For example, with respect to Dump commands, each of the agent control units 112a-112n recognizes that these commands request information maintained by the agent control unit 112, and in response, prepares the information for transmission to the master control device 202 according to the single command protocol. The single command protocol of the present invention and the communications passed between the master control unit 202 and the agent control units 112a-112n are described in greater detail below with respect to FIGS. 5 and 6.

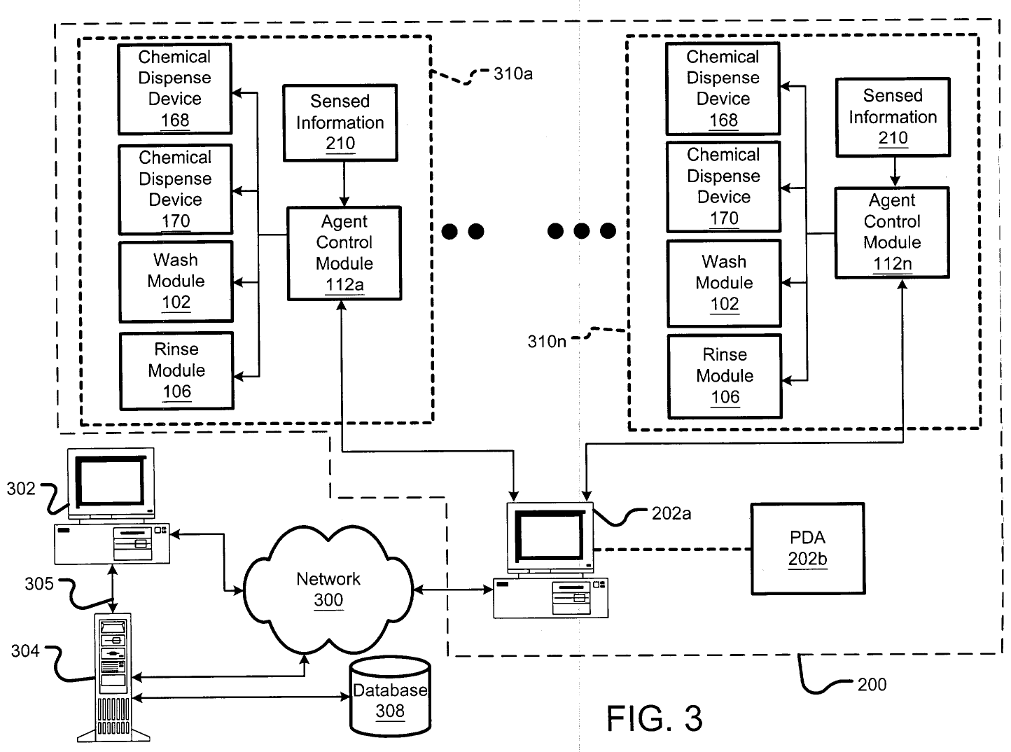

Referring now to FIG. 3, the master-agent system 200 illustrated in FIG. 2 is shown in more detail in accordance with an embodiment of the present invention. In FIG. 3, the master control unit 202 is shown operable to control processes of a group of utility devices 310a-310b using an agent control unit 112a-112n associated with each device 310a-310b. The master control unit 202 is shown in FIG. 3 as both a client computer 202a and a personal digital assistant (“PDA”) 202b in accordance with alternative embodiments. These alternative embodiments are illustrated using a dashed line between the client desktop computer 202a and the PDA 202b. An exemplary PDA that may serve as the master control unit 202b is the Jornada™ PDA manufactured by Hewlett-Packard™. For clarity, the master control unit is hereinafter referred to using reference numeral “202,” rather than “202a” or “202b.”

The master control unit 202 connects to a server computer 304 by way of a communications network 300. It should be appreciated that the communications network 300 may be any type of network known to those skilled in the art or an equivalence thereto. Some exemplary networks include, without limitation, the Internet, an Intranet, a private line network, or even a direct communication link between the master control unit 202 and the server computer 304. It should also be understood that the communications network 300 may utilize any number of communication technologies depending on functions required by the embodiment. Examples of specific technologies used in communications networks 300 contemplated include without limitation terrestrial, cellular, satellite, short-wave, and microwave connections to the Internet, directly between facilities using modems or other interface devices, or through other communications networks, such as local area networks or wide area networks. Any combination of these or other communications networks may be utilized and remain within the scope of the invention.

A remote client computer 302 connects to the server computer 304 through either the communications network 300 or a direct communication link 305. The remote client computer 302 is used by a field person to pass commands to and receive information from the master control unit 202 via the server computer 304, thereby allowing the field person to control and monitor processes of the group of utility devices 310a-310b from a remote location.

Commands are entered by the field person into the remote client computer 302 and then transmitted to the server computer 304 either by the direct communication link 305 or over the communications network 300. Each command specifies performance of a certain task by a utility device 310. As described above, exemplary task categories are Dump, Clear, Set and Reset. In an embodiment, the commands generated at the remote client computer 302 are formatted based on the single command protocol of the present invention. The server computer 304 may be associated with any number of master control units 202. Thus, the commands include information identifying the master control unit 202 responsible for controlling and monitoring the agent control unit 112 that is the intended destination for the command. In the embodiment of FIG. 3, the intended destination may be any one of the agent control units 112a-112n. Based on this identification information, the server computer 304 recognizes the appropriate master control unit 202 and prepares the command for transmission to that unit 202.

Upon receiving the commands transmitted by the second computer system 302, the server computer 304 either transmits the commands directly to the master control unit 202 or saves the commands to a local database 308 for subsequent transfer to the master control unit 202. If the commands are saved to the local database 308, the commands are queued for downloading by the master control unit 202 either upon request by the master control unit 202 or during a randomly, user-initiated or a regularly scheduled download time period allocated to that master control unit 202. In time, the commands are downloaded to the master control unit 202 for use in managing processes associated with a utility device 310 controlled and monitored by the master-agent system 200.

The master control unit 202 communicates with the plurality of agent control units 112a-112n associated with the plurality of utility devices 310a-310b, as described above with respect to FIG. 2. In addition to including information identifying the appropriate master control unit 202 for a command, the command includes information that identifies the agent control unit 112 that is the intended destination for the command. After a command is received by the master control unit 202 from the server computer 304, this identification information is analyzed to determine the destination agent control unit 112, which may be any agent control unit 112a-112n included within the master-agent system 200. The master control unit 202 then transmits the command to the appropriate agent control unit 112a-112n, thereby requesting performance of the task specified in the command.

The destination agent control unit 112a-112n receives the command from the master control unit 202 over either a wireless or a wired interface. In response to receiving the command, the agent control unit 112 examines the command to determine the task specified therein as well as the appropriate component that is to perform the specified task. The agent control unit 112 then directs the appropriate component to perform the task.

In an embodiment wherein the utility device 310 is a warewashing machine 100, as shown in FIG. 1, the agent control unit 112 is communicatively connected to the product dispense processor 146 of the chemical dispense device 168, the rinse agent processor 148 of the chemical dispense device 170, the wash module processor 156 and the rinse module processor 158 by control lines 128, 130, 154 and 152, respectively, such that control over these components may be administered under direction of the agent control unit 112 in response to reception and examination of a command from the master control unit 202. Furthermore, the agent control unit 112 receives sensed information that is used to control processes associated with the warewashing machine 100, and therefore the chemical dispense device 168, the chemical dispense device 170, the wash module processor 156 and the rinse module processor 158. The sensed information may be any type of information related to operation of the warewashing machine 100, including operating parameters and conditions, such as, without limitation, conductivity of the chemical solution, whether a particular component is active, velocity of the rinse or wash module arms, etc. These various types of sensed information may also be provided to the master control unit 202 in response to a request for such, as described in further detail in the following paragraph.

In an embodiment, the task may request information related to a process associated with the utility device 310. In this embodiment, the appropriate component for performing such a task is the agent control unit 112, which continuously monitors processes associated with the utility device 310 by controlling certain processing components and receiving information sensed during operation of the utility device 310. For example, with the utility device being a warewashing machine 100, such a task may request the agent control unit 112 to return the current conductivity setpoint value used to control when a chemical product is dispensed to the solution tank 140. In another embodiment, the task may request performance of a task by either a component of the utility device 310 or the agent control unit 112. Such a task may be, for example, activation or de-activation of the component and setting of a parameter used to locally control operation of the utility device 310 by the agent control unit 112. For example, with the utility device being a warewashing machine 100, such a task may modify the current conductivity setpoint value. Additionally, the task may set up a process that is to be monitored pursuant to a subsequent command. For example, with the utility device being a warewashing machine 100, the task may request activation of the wash module 106 such that a subsequent command can be issued to request operating parameters associated with the wash module 106, e.g., velocity of the arms, temperature of the chemical solution, etc.

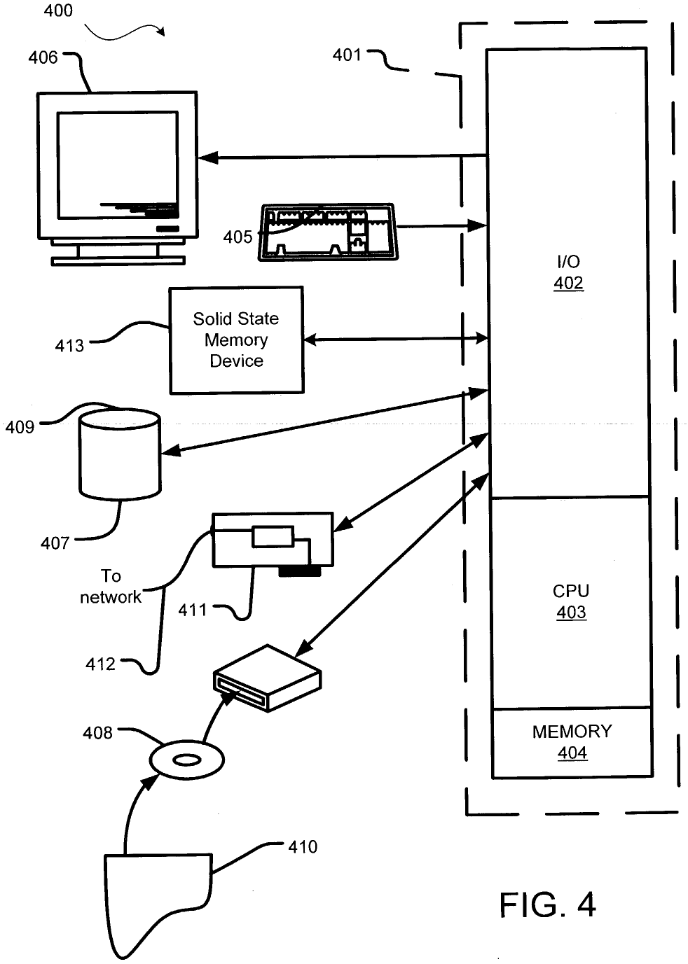

FIG. 4 depicts a computing system 400 capable of executing a program product embodiment of the present invention. One operating environment in which the present invention is potentially useful encompasses the computing system 400, such as, for example, the agent control unit 112, the master control unit 202, the server computer 304 and the client computer 302. In such a system, data and program files may be input to the computing system 400, which reads the files and executes the programs therein. Some of the elements of a computing system 400 are shown in FIG. 4 wherein a control module, illustrated as a processor 401, is shown having an input/output (I/O) section 402, a microprocessor, or Central Processing Unit (CPU) 403, and a memory section 404. The present invention is optionally implemented in software or firmware modules loaded in memory 404 and/or stored on a solid state, non-volatile memory device 413, a configured CD-ROM 408 or a disk storage unit 409. As such, the computing system 400 is used as a “special-purpose” machine for implementing the present invention.

Each of the above-noted forms of data storage are broadly included within the definition of “computer program product” used throughout the specification and the claims. That is, generally stated, a computer program product of the present invention may be a solid state, non-volatile memory device or a computer storage media readable by a computer system and encoding a computer program of instructions for executing a computer process. In another embodiment, the computer program product may also be a propagated signal on a carrier readable by a computing system and encoding a computer program of instructions for executing a computer process.

The I/O section 402 is connected to a user input module 405, e.g., a keyboard, a display unit 406 and one or more program storage devices, such as, without limitation, the solid state, non-volatile memory device 413, the disk storage unit 409, and the disk drive unit 407. The user input module 405 is shown as a keyboard, but may also be any other type of apparatus for inputting commands into the processor 401. The solid state, non-volatile memory device 413 is an embedded memory device for storing instructions and commands in a form readable by the CPU 403. In accordance with various embodiments, the solid state, non-volatile memory device 413 may be Read-Only Memory (ROM), an Erasable Programmable ROM (EPROM), Electrically-Erasable Programmable ROM (EEPROM), a Flash Memory or a Programmable ROM, or any other form of solid state, non-volatile memory. In accordance with one embodiment, the disk drive unit 407 is a CD-ROM driver unit capable of reading the CD-ROM medium 408, which typically contains programs 410 and data. Computer program products containing mechanisms to effectuate the systems and methods in accordance with the present invention may reside in the memory section 404, the solid state, non-volatile memory device 413, the disk storage unit 409 or the CD-ROM medium 408.

In accordance with an alternative embodiment, the disk drive unit 407 may be replaced or supplemented by a floppy drive unit, a tape drive unit, or other storage medium drive unit. A network adapter 411 is capable of connecting the computing system 400 to a network of remote computers via a network link 412. Examples of such systems include SPARC systems offered by Sun Microsystems, Inc., personal computers offered by IBM Corporation and by other manufacturers of IBM-compatible personal computers, and other systems running a UNIX-based or other operating system. A remote computer may be a desktop computer, a server, a router, a network PC (personal computer), a peer device or other common network node, and typically includes many or all of the elements described above relative to the computing system 400. Logical connections may include a local area network (LAN) or a wide area network (WAN). Such networking environments are commonplace in offices, enterprise-wide computer networks, intranets, and the Internet.

In accordance with a program product embodiment of the present invention, software instructions stored on the solid state, non-volatile memory device 413, the disk storage unit 409, or the CD-ROM 408 are executed by the CPU. In this embodiment, these instructions may be directed toward communicating data between a client and a server, detecting product usage data, analyzing data, and generating reports. Data, such as products usage data, corporate data, and supplemental data generated from product usage data or input from other sources, may be stored in memory section 404, or on the solid state, non-volatile memory device 413, the disk storage unit 409, the disk drive unit 407 or other storage medium units coupled to the system 400.

In accordance with one embodiment, the computing system 400 further comprises an operating system and usually one or more application programs. Such an embodiment is familiar to those of ordinary skill in the art. The operating system comprises a set of programs that control operations of the computing system 400 and allocation of resources. The set of programs, inclusive of certain utility programs, also provide a graphical user interface to the user. An application program is software that runs on top of the operating system software and uses computer resources made available through the operating system to perform application specific tasks desired by the user. In accordance with an embodiment, the operating system employs a graphical user interface 122 wherein the display output of an application program is presented in a rectangular area on the screen of the display device 406. The operating system is operable to multitask, i.e., execute computing tasks in multiple threads, and thus may be any of the following: Microsoft Corporation's “WINDOWS 95,” “WINDOWS CE,” “WINDOWS 98,” “WINDOWS 2000,” “WINDOWS XP” or “WINDOWS NT” operating systems, IBM's OS/2 WARP, Apple's MACINTOSH SYSTEM 8 operating system, X-windows, LINUX, etc.

In accordance with the practices of persons skilled in the art of computer programming, the present invention is described below with reference to acts and symbolic representations of operations that are performed by the computing system 400, i.e., the agent control unit 112, the master control unit 202, the server computer 304 or the client computer 302, unless indicated otherwise. Such acts and operations are sometimes referred to as being computer-executed. It will be appreciated that the acts and symbolically represented operations include the manipulations by the CPU 403 of electrical signals representing data bits causing a transformation or reduction of the electrical signal representation, and the maintenance of data bits at memory locations in the memory 404, the solid state, non-volatile memory device 413, the configured CD-ROM 408 or the storage unit 409 to thereby reconfigure or otherwise alter the operation of the computing system 400, as well as other processing signals. The memory locations where data bits are maintained are physical locations that have particular electrical, magnetic, or optical properties corresponding to the data bits.

The logical operations of the various embodiments of the present invention are implemented either manually and/or (1) as a sequence of computer-implemented steps running on a computing system, e.g., the agent control unit 112, the master control unit 202, the server computer 304 or the client computer 302, and/or (2) as interconnected machine modules within the computing system. The implementation is a matter of choice dependent on the performance requirements of the computing system implementing the invention. Accordingly, the logical operations making up the embodiments of the present invention described herein are referred to alternatively as operations, acts, steps or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

Referring now to FIG. 5, a process 500 for managing, i.e., controlling and monitoring, processes associated with a utility device within the master-agent system 200 is shown in accordance with an embodiment of the present invention. The management process 500 illustrates a process of operations performed by the master control unit 202 as a field person is utilizing the master control unit 202 to control and/or monitor processes associated with a utility device included within a group of utility devices. Because the described master control unit 202 is operable to control and/or monitor each device in the group of the utility devices, the management process 500 illustrates operations performed to control and/or monitor not only the described utility device, but also each device included within the group. As such, although a single iteration is all that is shown for the management process 500, it should be appreciated that the management process 500 may be performed sequentially for control over and/or monitoring of the same utility device or other utility devices in the group over a given period of time.

The management process 500 is performed by an operation flow that begins with a start operation 502 and concludes with a terminate operation 514. The start operation 502 is initiated as the field person activates the master control unit 202 to monitor and/or control processes associated with the utility device. From the start operation 502, the operation flow passes to a create operation 504.

The create operation 504 receives input from the field person and, based on said input, creates a command specifying a task that the field person is requesting that the agent control unit 112 of the utility device perform. The command is formatted by the create operation 504 into a command packet that each of the agent control units 112 associated with a utility device in the group of utility devices is programmed to recognize.

The command packet 600 is shown in FIG. 6 in accordance with an embodiment of the present invention. The command packet 600 includes various pre-defined fields 602-616 into which various forms of data are placed for use by the agent control unit 112 in interpreting the command. In this embodiment, the pre-defined fields include a start of header (SOH) field 602, an address field 604, a command field 606, a sub-command field 608, one or more parameter fields 610 and 614, wherein each parameter field is separated by a separation field 612, and an end of transmission (EOT) field 616. In an embodiment, the sub-command field 608, the one or more parameter fields 610 and 614, and the separation field 612 are optional in that a complete command packet 600 may include only one or any combination of these fields. The implementation is a matter of choice, depending on the task specified in the command packet 600. For illustrative purposes, however, the command packet 600 is shown and described in FIG. 6 as including all of these optional fields.

The SOH field 602 indicates the beginning of the command packet 600 to the agent control unit 112. In an embodiment, the SOH field 602 is a pre-defined single character outside the range of the conventional printable American National Standard Institute (ANSI) character set. “Pre-defined” refers to the fact that the master control unit 202 is programmed to transmit and the agent control unit 112 is programmed to recognize the single character as the beginning of a command packet 600.

The address field 604 includes identification of the agent control unit 112 that is the intended destination of the command packet 600, i.e., the agent control unit 112 associated with the utility device. In an embodiment, each agent control unit 112 in the system 200 is associated with a specific address in hexadecimal format. In this embodiment, the data placed in the address field 604 by the create operation 504 is therefore in hexadecimal format.

The command field 606, the sub-command field 608 and the one or more parameter fields 610 and 614 together specify a particular task to be performed by the agent control unit 112. In an embodiment, these fields 606, 608, 610 and 614 may be considered a single field because taken together these fields 606, 608, 610 and 614 specify the particular task. Data placed in the command field 606 indicates the category of the command to be administered by the agent control unit 112. The category of the command defines the type of action to be taken by the agent control unit 112 in performing the task associated with the command.

In an embodiment, the command categories include, without limitation, Reset commands, Clear commands, Dump commands and Set commands. A Reset command directs the agent control unit 112 to reboot. A Clear command directs the agent control unit 112 to clear specified information stored on the agent control unit 112. A Set command directs the agent control unit 112 to administer a specified task. A Dump command directs the agent control unit 112 to reply to the master control unit 202 with information related to processes of the utility device. In an embodiment, each command category is associated with a predefined hexadecimal number. “Pre-defined” refers to the fact that the master control unit 202 is programmed transmit and all agent control units 112 in the system 200 are programmed to recognize these hexadecimal numbers as specifying a particular command category. In this embodiment, the data placed in the command field 606 by the create operation 504 therefore represents one of these pre-defined hexadecimal numbers. As such, data placed in the command field 606 by the create operation 504 is in hexadecimal format as either an “R” for Reset, a “C” for clear, a “D” for dump and an “S” for Set.

The sub-command field 608 continues specifying the task by defining with more specificity the action to be performed by the agent control unit 112. In an embodiment, data in the sub-command field specifies an information type to be managed, i.e., controlled or monitored, based on the command packet 600. For example, if the command category relates to requesting information, the data included within the sub-command field 608 may explicitly point out the type of information that is requested. The type of information that may be specified in the sub-command field 608 is any type of data relating to any process associated with the utility device. In an embodiment, each information type is associated with a predefined hexadecimal number. “Pre-defined” refers to the fact that the master control unit 202 is programmed transmit and all agent control units 112 in the system 200 are programmed to recognize these hexadecimal numbers as specifying a particular information type. In this embodiment, the data placed in the sub-command field 608 by the create operation 504 therefore represents one of these pre-defined hexadecimal numbers. In accordance with an embodiment wherein the utility device is a warewashing machine 100, or component(s) thereof, e.g., chemical dispense device 168 or 170, exemplary information types that may be indicated by data within the sub-command field are listed below in Table 1. It should be appreciated that these exemplary information types are shown in Table 1 for illustration and should not be construed to limit the present invention to the information types listed.

TABLE 1

| Identifier (in | | |
|---|---|---|
| command packet) | Field Name | Information Type |
| I | ID Data | Device information |
| B | Binary | Range |
| M | Memory | Range |
| T | Time | Date and Time |
| U | User-Defined | User-defined data |
| A | Address | Device address |
| P | Program | Re-flash the Firmware |

The parameter fields 610 and 614, which are separated by a separation field 612, are used to further specify the task that the command and subcommand fields 606 and 608 have specified with respect to performing some action on a certain type of information. To accomplish this, the data placed in a first parameter field 610 by the create operation 504 relates to an actual parameter or operating condition that the field person either wants to control or receive information regarding. In an embodiment, each an actual parameter or operating condition is associated with a predefined hexadecimal number. “Pre-defined” refers to the fact that the master control unit 202 is programmed transmit and all agent control units 112 in the system 200 are programmed to recognize these hexadecimal numbers as specifying a particular parameter or operating condition. In this embodiment, the data placed in the parameter fields 610 and 614 by the create operation 504 therefore represent one of these pre-defined hexadecimal numbers. Exemplary parameters and operating conditions related to a warewashing machine 100, or component(s) thereof, e.g., chemical dispense device 168 or 170, are provided below in Table 2. It should be appreciated that these exemplary parameters and operating conditions are shown in Table 2 for illustration and should not be construed to limit the present invention to the parameters and operating conditions listed.

TABLE 2

| Identifier | | |
|---|---|---|
| (in command packet) | Field Name | Format |
| 1 | Detergent Setpoint | 1-3 Digits |
| 2 | Detergent Alarm Delay | 1-3 Digits |
| 3 | Detergent Initial Charge | 1-2 Digits |
| 4 | Detergent Dose | 1-2 Digits |
| 5 | Detergent Interval in Racks | 1 Digit |
| 6 | Rinse Pump Speed Setting | 2-3 Digits |
| 7 | Rinse Time Delay | 1-2 Digits |
| 8 | Rinse Time Limit | 1-2 Digits |
| 9 | Racks Before Wash Tank Change | 2-3 Digits |
| | Alarm | |
| 10 | Rinse Low Temperature | 1-3 Digits |
| 11 | One Rack Time | 1-2 Digits |
| 12 | Alarm State | 8 Digits |
| 13 | Total Rinse Time | 1-3 Digits |
| 14 | Probe Conductivity Reading | 1-4 Digits |
| 15 | Probe Temperature Reading | 1-3 Digits |
| 17 | Rinse Temperature Reading | 1-3 Digits |
| 18 | Fault History | 8 digits |
| 19 | System Configuration | 8 Digits |
| 20 | Input/Output Signals | 8 Digits |
| 21 | Prime Rinse Agent | On or Off |
| 22 | Dispense Rinse Agent | On or Off |
| 23 | Dispense Detergent Command | On or Off |

If the field person requests control over an operating parameter or condition of the utility device, a second parameter field 614 is used to carry the data for use in defining, modifying or otherwise setting the appropriate operating parameter or condition. Otherwise, if the field person requests information related to an operating parameter or condition rather than to administer control over a process associated with the utility device, the second parameter field 614 remains empty. The end of the command packet 600 sent to the agent control unit 112 by the master control unit 202 is detected by the agent control unit 112 based on the EOT field 616. In an embodiment, the EOT field 616 is a pre-defined single character outside the range of the conventional printable ANSI character set. “Pre-defined” refers to the fact that the master control unit 202 is programmed to transmit and the agent control unit 112 is programmed to recognize the single character as the end of a command packet 600.

Referring back to the management process 500 of FIG. 5, the operation flow passes to a transmit operation 506 after the command packet 600 is created by the create operation 504. The transmit operation 506 transmits the command packet 600 from the master control unit 202 to the agent control unit 112 having the address specified in the address field 604. In an embodiment, transmission of the command packet 600 is made over a wired interface between the master control unit 202 and the agent control unit 112. In another embodiment, transmission of the command packet is made over a wireless interface between the master control unit 202 and the agent control unit 112. After the command packet 600 has been transmitted from the master control unit 202, the operation flow passes to a first query operation 508.

The first query operation 508 determines whether the agent control unit 112 has received the command packet transmitted by the transmit operation 506. In an embodiment, this determination is made based on whether an acknowledgment signal has been received from the agent control unit 112 within a predetermined period of time. In an embodiment, the acknowledgment signal is a predefined single character outside of the range of conventionally known ANSI character set. “Pre-defined” refers to the fact that the agent control unit 112 is programmed to transmit and the master control unit 202 is programmed to recognize the single character as an indication that the complete command packet 600 was in fact received by the agent control unit 112.

Referring back to the first query operation 508, if an acknowledgment signal has been received within the predetermined period of time, the operation flow passes to a second query operation 510, which is described in the preceding paragraph. Otherwise, if an acknowledgment signal has not been received within this predetermined period of time, it is assumed that the agent control unit 112 never received the command packet 600 and the operation flow passes back to the create operation 504 to reconstruct the packet 600 for re-transmission to the agent control unit 112.

Also, in an alternative embodiment, if the agent control unit 112 receives part of the command packet transmission, but not the complete packet 600, the agent control unit 112 may transmit an error signal to the master control unit 202 indicating such. Like the acknowledgment signal, the error signal is a pre-defined single character outside of the range of the printable ANSI character set. “Pre-defined” refers to the fact that the agent control unit 112 is programmed to transmit and the master control unit 202 is programmed to recognize the single character as an indication that the complete command packet 600 was in fact not received by the agent control unit 112. The agent control unit 112 determines that a complete packet has not been received if the unit 112 receives the SOH field 602, but does not receive the EOT field 616 within a predetermined period of time. In this embodiment, if the first query operation 508 receives an error signal, the operation flow is passed back to the create operation 504 and continues as previously described. Operation of the agent control unit 112 is shown and described in more detail with respect to FIG. 7.

The operation flow passes from the first query operation 508 to the second query operation upon reception of an acknowledgment signal. The second query operation 510 determines whether the command packet 600 requests that the agent control unit 112 respond with information related to a process associated with the utility device. In an embodiment, such a determination is made based on the command category of the command packet 600. If the command is a Dump command, then the second query operation 510 determines that the master control unit 202 is to await the reception of information transmitted from the agent control unit 112 and branches the operation flow to the receive operation 512. The receive operation 512 waits for and thereafter receives the information requested by the command packet 600. The information is transmitted from the agent control unit 112 to the master control unit 202 by way of either a wired interface or a wireless interface. From the receive operation 512, the operation flow concludes at the terminate operation 514. If the command is a Set command, then the second query operation 510 branches the operation flow to the terminate operation 514 because the command packet 600 did not request information from the agent control unit 112. The operation flow therefore concludes without the master control unit 202 awaiting reception of requested information.

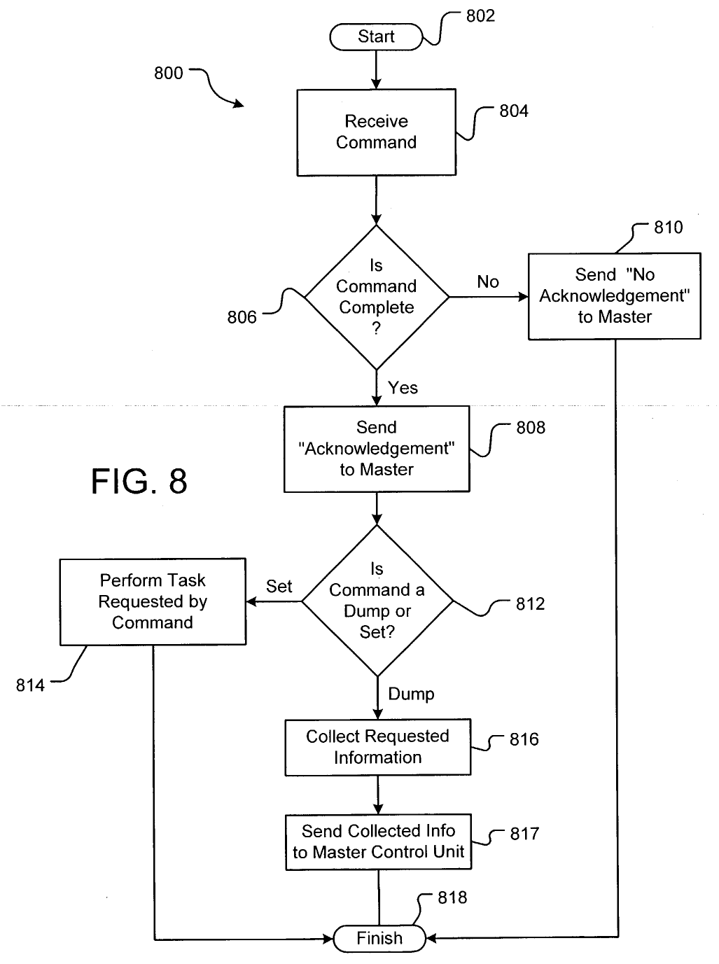

Referring now to FIG. 8, a process 800 for managing, i.e., controlling and monitoring, processes of a utility device within the master-agent system 200 is shown in accordance with an embodiment of the present invention. The management process 800 illustrates a process of operations performed by the agent control unit 112 as a field person is utilizing a master control unit 202 to control and/or monitor processes associated with a utility device via an agent control unit 112.

Although a single iteration is all that is shown for the management process 800, it should be appreciated that the management process 800 may be performed multiple times to enable a field person to control and monitor the utility device over a given period of time.

The management process 800 is performed by an operation flow that begins with a start operation 802 and concludes with a terminate operation 818. The start operation 802 is initiated as the field person activates the master control unit 202 to monitor and/or control processes associated with the utility device. From the start operation 802, the operation flow passes to a receive operation 804.

The receive operation 804 awaits reception of a command packet 600 transmitted by the master control unit 202. After the command packet 600 is received, the operation flow passes to a first query operation 806. The first query operation 806 determines whether the receive operation 804 received the command packet 600 without error. That is, the first query operation 806 checks to make sure that the command packet 600 is a complete packet. In an embodiment, such a determination is made by detecting whether the EOT field 616 of the command packet 600 has been received. If the EOT field 616 has not been detected, the operation flow passes to a first notify operation 810. The first notify operation 810 transmits an error signal back to the master control unit 202 indicating that the complete command packet 600 did not reach the agent control unit 112. As noted above, the error signal is a pre-defined single character outside of the range of the printable ANSI character set. “Pre-defined” refers to the fact that the agent control unit 112 is programmed to transmit and the master control unit 202 is programmed to recognize the single character as an indication that the complete command packet 600 was in fact not received by the agent control unit 112. Under such circumstances, the master control unit 202 notifies the field person of the error and the field person decides whether to re-attempt transmission of that command packet 600. From the first query operation, the operation flow concludes at the terminate operation 810.

If the first query operation 806 determines that the EOT field 616 was in fact detected, the operation flow passes to a second notify operation 808. The second notify operation 808 sends an acknowledgment signal for transmission to the master control unit 202. In an embodiment, the acknowledgment signal is a pre-defined single character outside of the range of conventionally known ANSI character set. “Pre-defined” refers to the fact that the agent control unit 112 is programmed to transmit and the master control unit 202 is programmed to recognize the single character as an indication that the complete command packet 600 was in fact received by the agent control unit 112. From the second notify information 608, the operation flow passes to a second query operation 812.

The second query operation 812 examines the command packet 600 received from the master control unit 202 to determine whether the task specified in the command packet 600 is directing the agent control unit 112 to (1) administer performance of an operation related to a process associated with the utility device; or (2) reply to the command with requested information related to a process associated with the utility device. In an embodiment, such a decision may be made by examining the command field 606. If the second query operation 812 detects that the command field 606 contains data identifying a Dump command, then the command packet 600 specifies a reply to be made with requested information. On the other hand, if the second query operation 812 detects that the command field 606 contains data identifying a Set, Reset or Clear command, then the command packet 600 specifies performance of an operation related to a process associated with the utility device. With these commands, the master control unit 202 is not requesting a reply from the agent control unit 212, but rather only control over a certain process performed by at least one component associated with the utility device.

The operation flow passes from the second query operation 812 to the perform operation 814 if the command packet 600 is specifying that the agent control unit 212 manage performance of a certain operation rather than reply with requested information. The perform operation 814 examines the command packet 600 to determine the operation that is requested as well as the component(s) associated with the utility device responsible for the performance of said operation. After this information is gathered by examination of the command packet 122, the perform operation 814 directs the appropriate component(s) to perform the specified operation. From the perform operation 814, the operation flow concludes at the terminate operation 818.

The operation flow passes from second query operation 812 to the collect operation 816 if task specified in the command packet 600 is specifying that the agent control unit 212 reply to the command with requested information. The collect operation 816 examines the command packet 600 to determine the specific information requested by the master control unit 202. Once determined, the collect information 616 collects this information, and once collected, creates a reply packet 624 (FIG. 7) for transmitting the collected information between the agent control unit 112 and the master control unit 202. In an embodiment, the reply packet 624 includes a SOH field 602 and an EOT field 616 as well as a third field therebetween. The third field is a reply field 626 into which data requested by the master control unit 202 is placed by the collect operation 816. After the reply packet 624 is created, the operation flow passes to a reply operation 817. The reply operation 817 transmits the created reply packet 624 to the master control unit 202. After the reply packet 624 has been transmitted, the operation flow concludes at the terminate operation 818.

It will be clear that the present invention is well adapted to attain the ends and advantages mentioned, as well as those inherent therein. While a presently preferred embodiment has been described for purposes of this disclosure, various other embodiments are well within the scope of the present invention. For example, Table 3, shown below, shows various predefined single characters outside of the range of printable ANSI characters for use in communications between the master control unit 202 and the agent control units 112 in accordance with an embodiment of the invention. Additionally, a command packet 600 may include a checksum field (not shown) for validation, i.e., error checking, purposes in accordance with another embodiment contemplated by the present invention.

TABLE 3

| | | |
|---|---|---|
| SOH | Hex 01 | Start of header (SOH) |
| ETX | Hex 03 | Cancel a command (same as Hex 17) |
| EOT | Hex 04 | End of text (EOT) |
| ACK | Hex 06 | Positive acknowledgment (acknowledgment signal) |
| XON | Hex 11 | Allow incoming data |
| XOF | Hex 13 | Disallow incoming data |
| NAK | Hex 15 | Negative acknowledgment (error signal) |
| CAN | Hex 17 | Cancel a command (same as Hex 03 for applications that |
| | | intercept Hex 03 such as Windows Terminal) |

It should also be appreciated that various changes and/or modifications may be made which are well within the scope of the present invention. For example, although the master-agent system 200 is described as a master control unit 202 issuing a command to only one agent control unit 112 at a time, the master control unit 202 may simultaneously issue multiple commands to more than one agent control units 112 in accordance with an alternative embodiment. Additionally, a master control unit 202 and each of the agent control units 112 associated with the master control unit 202 may include a buffer for receiving packets transmitted therebetween. Furthermore, the ability of the master control unit 202 to enable control over an agent control unit 112 may include the ability to add to, modify or delete programming associated with the software or firmware accessed by the control module of the agent control unit 112.

The warewashing system 100 is shown in FIG. 1 to illustrate embodiments of the present invention. The agent control unit 112 associated with the warewashing system 100 is described as locally controlling concentration of a chemical solution contained in the solution tank 140 based on sensed conductivity of the chemical solution currently contained in the solution tank 140. It should be appreciated that the agent control unit 112 may also control conductivity of the chemical solution based on time-based methods. Such time-based methods may therefore be managed by a field person using the master-agent system 200 of the present invention.

Numerous other changes may be made which will readily suggest themselves to those skilled in the art and which are encompassed in the spirit of the invention disclosed and as defined in the appended claims.

What is claimed is:

1. A system for managing processes associated with a plurality of chemical dispense devices, wherein each chemical dispense device dispenses a chemical product to a utility device for use in applying the chemical product to one or more objects, the system comprising:
a first agent control unit communicatively connected to a first chemical dispense device operable to dispense a first chemical product to a first utility device, wherein the first agent control unit locally administers processes associated with the first chemical dispense device;
a second agent control unit communicatively connected to a second chemical dispense device operable to dispense a second chemical product to a second utility device, wherein the second agent control unit locally administers processes associated with the second chemical dispense device; and
a master control unit for use by a field person in monitoring and controlling processes associated with the first chemical dispense device and the second chemical dispense device by issuing instructions in a pre-defined command format recognizable to both the first agent control unit and the second agent control unit, wherein the first and second agent control units locally administer processes associated with the first and second chemical dispense devices in response to receipt of the instructions.

2. A system as defined in claim 1, wherein the first utility device and the second utility device perform substantially different functions and operate in a substantially different manner with respect to one another.

3. A system as defined in claim 2, wherein the first utility device is a warewashing machine and the second utility device is a laundry machine.

4. A system as defined in claim 2, wherein the first utility device is a warewashing machine and the second utility device is a clean-in-place system.

5. A system as defined in claim 1, wherein the first utility device and the second utility device perform a substantially similar function and operate in a substantially similar manner with respect to one another.

6. A system as defined in claim 5, wherein the first utility device and the second utility device are warewashing machines.

7. A system as defined in claim 1, wherein the master control unit transmits instructions to and receives responses from the first agent control unit over a wireless interface communicatively connecting the master control unit to the first agent control unit.

8. A system as defined in claim 1, wherein the master control unit transmits instructions to and receives responses from the first agent control unit over a wire-based interface communicatively connecting the master control unit to the first agent control unit.

9. A system as defined in claim 1, wherein the master control unit comprises a client computer, the client computer operably connecting to and communicating with the first agent control unit and the second agent control unit by way of an interface selected from the group consisting of a wireless interface and a wire-based interface.

10. A system as defined in claim 9, further comprising:
a server computer communicating with the client computer over a first network connection, the server computer receiving the instructions input by the field person and transmitting the instructions to the client computer over the first network connection.

11. A system as defined in claim 10, wherein the client computer receives the instructions transmitted by the server computer and manipulates each instruction into the pre-defined command format for transmission to one of the first and second agent control units.

12. A system as defined in claim 11, further comprising:
a remote client computer communicating with the server computer over a second network connection wherein the field person inputs the instructions to the remote client computer for transmission to the server computer.

13. A system as defined claim 12, wherein the second network connection comprises the Internet.

14. A system as defined in claim 12, wherein the remote client computer is a workstation communicatively connected to the server computer by a direct communication link.

15. A system as defined in claim 10, wherein the first network connection comprises the Internet.

16. A system as defined in claim 10, wherein the first network connection comprises an intranet.

17. A system as defined in claim 1, wherein the pre-defined command format specifies a packet-based structure for communications passed between the master control unit and the first and second agent control units.

18. A system as defined in claim 17, wherein each instruction issued by the master control unit comprise:
a first field having data identifying a beginning of an instruction issued by the master control agent;
a second field having data identifying an address for an intended destination of the instruction, wherein the intended destination is one of the first and second agent control units;
a third field having data specifying a task to be administered by the intended destination; and
a fourth field having data identifying an end of the instruction.

19. A system as defined in claim 18, wherein the task specified by the data in the third field of the instruction requests information from the intended destination, the information relating to an operating parameter of a process associated with the utility device to which the intended destination is communicatively connected.

20. A system as defined in claim 19, wherein the third field comprises:
a command field having data specifying a type of action to be performed by the intended destination;
a sub-command field having data specifying a type of information that is to be returned to the master control unit, wherein the type of information relates to an operating parameter to be used to control a process associated with the utility device to which the intended destination is communicatively connected; and
a parameter field having data specifying the operating parameter.

21. A system as defined in claim 18, wherein the task specified by the data in the third field of the instruction requests performance of an operation of a process associated with the utility device to which the intended destination is communicatively connected.

22. A system as defined in claim 21, wherein the third field comprises:
a command field having data specifying a type of action to be performed by the intended destination;
a sub-command field having data specifying a type of information that is to be updated by the intended destination, wherein the type of information relates to an operating parameter to be used to control a process associated with the utility device to which the intended destination is communicatively connected; and
a parameter field having data specifying a value that is to be set for the operating parameter.

23. A method for enabling a field person to manage processes associated with a plurality of chemical dispense devices, wherein each chemical dispense device dispenses a chemical product to a utility device for use in applying the chemical product to one or more objects, the method comprising acts of:
receiving a first instruction related to managing one or more processes associated with a first chemical dispense device operable to dispense a first chemical product to a first utility device;
receiving a second instruction related to managing one or more processes associated with a second chemical dispense device operable to dispense a second chemical product to a first utility device;
formatting the first instruction into a first command packet and the second instruction into a second command packet, wherein the first and second command packets are in a pre-defined format recognizable to both a first agent control unit communicatively connected to and locally administering processes associated with the first chemical dispense device and a second agent control unit communicatively connected to and locally administering processes associated with the second chemical dispense device; and
transmitting the first command packet to the first agent control unit and the second command packet to the second agent control unit.

24. A method as defined in claim 23, wherein the first and second instructions are input by the field person using an input device on a handheld computing device and wherein the receiving act, the formatting act and the transmitting act are performed by the handheld computing device.

25. A method as defined in claim 24, wherein the transmitting act comprises:
sending the first command packet to the first agent control unit over a wireless interface communicatively connecting the handheld computing device and the first agent control unit.

26. A method as defined in claim 24, wherein the transmitting act comprises:
sending the first command packet to the first control unit over a wire-based transmission media communicatively connecting the handheld computing device and the first agent control unit.

27. A method as defined in claim 23, wherein the first and second instructions are input by the field person using an input device of a remote computer and transmitted by the remote computer to a server computer, wherein the receiving, transmitting and formatting acts are performed by a client computing device communicating with the server computer over a network connection.

28. A method as defined in claim 27, wherein the transmitting act comprises:
sending the first command packet to the first agent control unit over a wireless interface communicatively connecting the client computing device and the first agent control unit.

29. A method as defined in claim 27, wherein the transmitting act comprises:
sending the first command packet to the first control unit over a wire-based transmission media communicatively connecting the client computing device and the first agent control unit.

30. A method as defined in claim 27, wherein client computing device is a desktop computer.

31. A method as defined in claim 27, wherein the client computing device is a personal digital assistant.

32. A system as defined in claim 23, wherein the first utility device and the second utility device perform substantially different functions and operate in a substantially different manner with respect to one another.

33. A system as defined in claim 32, wherein the first utility device is a warewashing machine and the second utility device is a laundry machine.

34. A system as defined in claim 32, wherein the first utility device is a warewashing machine and the second utility device is a clean-in-place system.

35. A system as defined in claim 23, wherein the first utility device and the second utility device perform substantially similar functions and operate in a substantially similar manner with respect to one another.

36. A system as defined in claim 35, wherein the first utility device and the second utility device are warewashing machines.

37. A method as defined in claim 23, further comprising:
in response to transmitting the first command packet to the first agent control unit, receiving from the first agent control unit an acknowledgement response indicating that the first command packet has been received in its entirety by the first agent control unit.

38. A method as defined in claim 37, wherein the first command packet requests information from the first agent control unit, the information relating to an operating parameter associated with a process of the first utility device, the method further comprising:
receiving the requested information from the first utility device.

39. A method as defined in claim 37, wherein the first command packet requests performance of an operation of a process associated with the first utility device, the first agent control unit administering performance of the operation in response to receiving the first command packet.

40. A method as defined in claim 39, wherein the operation relates to setting an operating parameter used to control the process associated with the first utility device.

41. A method as defined in claim 23, further comprising:
in response to transmitting the first command packet to the first agent control unit, receiving from the first agent control unit an error response indicating that the first command packet has not been received in its entirety by the first agent control unit.

42. A system for enabling a field person to manage processes associated with a plurality of utility devices, wherein each of the plurality of utility devices is communicatively connected to an agent control unit locally administering processes associated with the utility device, the system comprising:
means for receiving instructions related to managing one or more processes associated with the plurality of utility devices;
means for formatting the instructions into command packets adhering to a packet-based structure recognizable to each agent control unit communicatively connected to one of the plurality of utility devices, wherein the packet-based structure comprises:
a first field having data identifying a beginning of each packet;
a second field having data identifying an address for an intended destination of each packet, wherein the intended destination is one of the plurality of agent control units;
a third field having data specifying a task to be administered by the intended destination; and
a fourth field having data identifying an end of each packet, and
means for transmitting the command packets the agent control units, wherein each agent control unit locally administers processes associated with the utility device to which the agent control unit is connected in response to receipt of a command packet.

43. A system as defined in claim 42, wherein the transmitting means is selected from the group consisting of a wire-based interface and a wireless interface.

44. A system as defined in claim 42, wherein the task specified by the data in the third field of the packet-based structure requests information from the intended destination, the information being an operating parameter related to a process associated with the utility device to which the intended destination is communicatively connected.

45. A system as defined in claim 42, wherein the task specified by the data in the third field of the packet-based structure requests performance of an operation of a process associated with the utility device to which the intended destination is communicatively connected.

46. A system as defined in claim 42, wherein the third field of the packet-based structure comprises:
a command field having data specifying a type of action to be performed by the intended destination;
a sub-command field having data specifying a type of information that is to be updated by the intended destination, wherein the type of information relates to an operating parameter to be used to control a process associated with the utility device to which the intended destination is communicatively connected; and
a parameter field having data specifying a value that is to be set for the operating parameter.

47. A system as defined in claim 42, wherein the third field of the packet-based structure comprises:
a command field having data specifying a type of action to be performed by the intended destination.

48. A system as defined in claim 42, wherein the third field of the packet-based structure comprises:
a command field having data specifying a type of action to be performed by the intended destination; and
a sub-command field having data specifying a type of information that is to be updated by the intended destination, wherein the type of information relates to an operating parameter to be used to control a process associated with the utility device to which the intended destination is communicatively connected.

49. A system as defined in claim 42, further comprising:
a first agent control unit communicatively connected to and locally administering processes associated with a first utility device, wherein receiving means receives a first instruction related to managing one or more processes associated with the first utility device and the formatting means formats the first instruction into a first command packet adhering to the packet-based structure; and
a second agent control unit communicatively connected to and locally administering processes associated with the second utility device, wherein receiving means receives a second instruction related to managing one or more processes associated with the second utility device and the formatting means formats the second instruction into a second command packet adhering to the packet-based structure, the intended destination identified by the address included in the second field being one of the first and second agent control units.

50. A system as defined in claim 49, further comprising:
a means for receiving information transmitted from the first agent control unit and the second agent control unit.

51. A system as defined in claim 50, wherein the third field of the packet-based structure comprises:
a command field having data specifying a type of action to be performed by the intended destination;
a sub-command field having data specifying a type of information that is to be returned to the master control unit by way of the fourth means, wherein the type of information relates to an operating parameter to be used to control a process associated with the utility device to which the intended destination is communicatively connected; and
a parameter field having data specifying the operating parameter.

52. A system as defined in claim 50, wherein the means for receiving information transmitted from the first agent control unit and the second agent control unit receives from the first agent control unit an acknowledgement response indicating that the first command packet has been received in its entirety by the first agent control unit.

53. A system as defined in claim 50, wherein the means for receiving information transmitted from the first agent control unit and the second agent control unit receives from the first agent control unit an error response indicating that the first command packet has not been received in its entirety by the first agent control unit.

54. A system as defined in claim 49, wherein the first utility device and the second utility device perform substantially different functions and operate in a substantially different manner with respect to one another.

55. A system as defined in claim 54, wherein the first utility device is a chemical dispense system and the second utility device is a warewashing machine.

56. A system as defined in claim 54, wherein the first utility device is a clean-in-place system and the second utility device is a warewashing machine.

57. A system as defined in claim 54, wherein the first utility device is a laundry system and the second utility device is a warewashing machine.

58. A system as defined in claim 49, wherein the first utility device and the second utility device perform substantially similar functions and operate in a substantially similar manner with respect to one another.

59. A system as defined in claim 58, wherein the first utility device and the second utility device are warewashing machines.

60. A computer program product readable by a computing system and encoding a computer program for executing a computer process for enabling a field person to manage processes associated with a plurality of chemical dispense devices, wherein each chemical dispense device dispenses a chemical product to a utility device for use in applying the chemical product to one or more objects, the computer process comprising acts of:
receiving a first instruction related to managing one or more processes associated with a first chemical dispense device operable to dispense a first chemical product to a first utility device;
receiving a second instruction related to managing one or more processes associated with a second chemical dispense device operable to dispense a second chemical product to a first utility device;
formatting the first instruction into a first command packet and the second instruction into a second command packet, wherein the first and second command packets are in a pre-defined format recognizable to both a first agent control unit communicatively connected to and locally administering processes associated with the first chemical dispense device and a second agent control unit communicatively connected to and locally administering processes associated with the second chemical dispense device; and
transmitting the first command packet to the first agent control unit and the second command packet to the second agent control unit.

61. A computer program product as defined in claim 60, further comprising:
in response to transmitting the first command packet to the first agent control unit, receiving from the first agent control unit an acknowledgement response indicating that the first command packet has been received in its entirety by the first agent control unit.

62. A computer program product as defined in claim 61, wherein the first command packet requests information from the first agent control unit, the information relating to an operating parameter associated with a process of the first utility device, the method further comprising:
receiving the requested information from the first utility device.

63. A computer program product as defined in claim 61, wherein the first command packet requests performance of an operation of a process associated with the first utility device, the first agent control unit administering performance of the operation in response to receiving the first command packet.

64. A computer program product as defined in claim 63, wherein the operation relates to setting an operating parameter used to control the process associated with the first utility device.

65. A computer program product as defined in claim 60, further comprising:
in response to transmitting the first command packet to the first agent control unit, receiving from the first agent control unit an error response indicating that the first command packet has not been received in its entirety by the first agent control unit.

66. An apparatus for managing one or more processes associated with a plurality of utility devices each controlled and monitored by an agent control unit, wherein a process of the one or more processes relates to dispensing a chemical product to one of the plurality of utility devices, the apparatus comprising:
an input module receiving an instruction from a field person, the instruction related to management of the dispensing process by a specified agent control unit;
a format module formatting the instruction into a pre-defined packet-based structure recognizable to all agent control units associated with the plurality utility devices; and
a communication module transmitting the instruction to the specified agent control unit and receiving from the specified agent control unit a message in response to receipt of the instruction by the specified agent control unit.

67. An apparatus as defined in claim 66, wherein the pre-defined packet-based structure comprises:
a first field having data identifying a beginning of each packet;
a second field having data identifying an address for an intended destination of each packet, wherein the intended destination is an agent control unit controlling and monitoring one of the plurality of utility devices;
a third field having data specifying a task to be administered by the intended destination; and
a fourth field having data identifying an end of each packet.

68. An apparatus as defined in claim 67, wherein the task specified by the data in the third field of the packet-based structure requests information from the intended destination, the information being an operating parameter related to a process associated with the utility device to which the intended destination is communicatively connected.

69. An apparatus as defined in claim 68, wherein the message received from the specified agent control unit comprises the requested operating parameter.

70. An apparatus as defined in claim 67, wherein the task specified by the data in the third field of the packet-based structure requests performance of an operation of a process associated with the utility device to which the intended destination is communicatively connected.

71. An apparatus as defined in claim 66, wherein the communication module transmits information to and receives information from the agent control units over a wireless communication interface.

72. An apparatus as defined in claim 66, wherein the communication module transmits information to and receives information from the agent control units over a wire-based communication interface.

73. An apparatus as defined in claim 66, wherein the message received from the specified agent control unit comprises an error response indicating that the instruction has not been received in its entirety by the specified agent control unit.

74. An apparatus as defined in claim 66, wherein the message received from the specified agent control unit comprises an acknowledgment response indicating that the instruction has been received in its entirety by the specified agent control unit.
